(19) United States
(12) Patent Application Publication
(10) Pub. No.: US 2013/0271551 A1
(43) Pub. Date: Oct. 17, 2013

(54) IMAGE FORMING APPARATUS

(71) Applicant: CANON KABUSHIKI KAISHA, Tokyo (JP)

(72) Inventor: Kosuke Yasaki, Toride-shi (JP)

(73) Assignee: CANON KABUSHIKI KAISHA, Tokyo (JP)

(21) Appl. No.: 13/859,170

(22) Filed: Apr. 9, 2013

(30) Foreign Application Priority Data
Apr. 17, 2012 (JP) 2012-094179
Mar. 14, 2013 (JP) 2013-052429

(51) Int. Cl. B41J 2/435

(52) U.S. Cl. CPC G03G 15/043
USPC 347/224

(57) ABSTRACT

In an image forming apparatus, in a state where the control unit controls the rotation speed of the photosensitive member to Vp1, a control unit causes N light-emitting elements out of the plurality of light-emitting elements to emit the light beams and controls the rotation speed of the rotating polygonal mirror to Vr1, and in a state where the control unit controls the rotation speed of the photosensitive member to Vp2 lower than Vp1, the control unit causes M (M<N) light-emitting elements out of the plurality of light-emitting elements to emit the light beams and controls the rotation speed of the rotating polygonal mirror to Vr2 different from Vr1.

### BACKGROUND OF THE INVENTION

1. Field of the Invention

The present invention relates to an image forming apparatus.

2. Description of the Related Art

In recent years, electrophotographic image forming apparatuses are used even in the fields of print on demand and printing, and demand for high image quality, in particular, density variation is growing. On the other hand, when paper to be printed is specialty paper such as thick paper or OHP paper and needs more heat than plain paper to fix toners, and the specialty paper is passed through the fixing unit as quickly as the plain paper or the like, no output image of the desired quality can be obtained. To solve this problem, a method is conventionally known, which passes specialty paper through the fixing unit at a speed lower than that of plain paper so as to prolong the passage time of the specialty paper through the fixing unit, thereby applying sufficient heat to the toner image on the specialty paper and improving the image quality. However, if the speed of the specialty paper through the fixing unit is changed, the speed of other image forming processes (to be referred to as a process speed hereinafter) needs to be changed.

For example, Japanese Patent Laid-Open No. 2003-011420 discloses an image forming apparatus in which a light beam emitted by a light source including a plurality of light-emitting elements is reflected by a rotating polygonal mirror and thus scans on a photosensitive member, and an electrostatic latent image formed on the photosensitive member by the scan of the light beam is developed using a toner, thereby forming an image. Japanese Patent Laid-Open No. 2003-011420 discloses an image forming apparatus that changes the number of light-emitting elements to emit light while maintaining the rotation speed of the rotating polygonal mirror constant at the time of changing the process speed.

In Japanese Patent Laid-Open No. 2002-196646, the process speed is changed by refraining from using some of the reflecting surfaces of the rotating polygonal mirror for light beam deflection.

A case in which the number of light sources to emit light to form an electrostatic latent image is selected, as in Japanese Patent Laid-Open No. 2003-011420, or a case in which control is performed to refrain from using some of the reflecting surfaces of the rotating polygonal mirror for light beam deflection, as in Japanese Patent Laid-Open No. 2002-196646, will be considered. For example, an image forming apparatus which includes a rotating polygonal mirror provided with four reflecting surfaces, and forms an image using a light source including 16 light-emitting elements for emitting light at a specific process speed (1/1), as shown in Item 1 of FIG. 7, will be described. When controlling the process speed to 1/2 (Item 2 of FIG. 7), if the number of light-emitting elements used to form an electrostatic latent image and the number of reflecting surfaces can be divided by the reduction ratio “2”, the scan interval corresponds to the resolution of the image forming apparatus. However, when changing the process speed to another speed (for example, 2/3 shown in Item 3 of FIG. 7), an interval smaller than one scan line of the light beam (smaller than one pixel) cannot be controlled, as shown in Items 4 and 5 of FIG. 7, and the scan line interval becomes uneven. For this reason, the output image has density unevenness or stripes, and its quality is poorer as compared to the original image.

### SUMMARY OF THE INVENTION

The present invention has been made in consideration of the above-described problem, and provides an image forming apparatus capable of changing the process speed to an arbitrary speed.

According to one aspect of the present invention, there is provided an image forming apparatus comprising: a photosensitive member to be rotated; a light source including a plurality of light-emitting elements each of which is controllable separately and is configured to emit a light beam to form an electrostatic latent image on the photosensitive member, the plurality of light-emitting elements being arranged such that the light beams emitted from each of the plurality of light-emitting elements expose different positions of the photosensitive member in the direction of rotation of the photosensitive member; a rotating polygonal mirror configured to deflect the plurality of light beams emitted from the light source such that the plurality of light beams each scan the photosensitive member; and a control unit configured to control a speed of rotation of the photosensitive member, a speed of rotation of the rotating polygonal mirror, and the number of light-emitting elements, out of the plurality of light-emitting elements, being used to emit a light beam to form an electrostatic latent image on the photosensitive member, wherein in a state where the control unit controls the speed of rotation of the photosensitive member to be Vp1, the control unit causes N light-emitting elements out of the plurality of light-emitting elements to emit light beams and controls the speed of rotation of the rotating polygonal mirror to be Vr1, and in a state where the control unit controls the speed of rotation of the photosensitive member to be Vp2, where Vp2 is lower than Vp1, the control unit causes M light-emitting elements, out of the plurality of light-emitting elements, to emit the light beams, where M<N, and controls the speed of rotation of the rotating polygonal mirror to be Vr2 which is different to Vr1.

According to another aspect of the present invention, there is provided an image forming apparatus comprising: a photosensitive member to be rotated; a light source including a plurality of light-emitting elements each of which is controllable separately and is configured to emit a light beam to form an electrostatic latent image on the photosensitive member when in use, the plurality of light-emitting elements being arranged such that the light beams emitted from each of the plurality of light-emitting elements expose different positions on the photosensitive member in the direction of rotation of the photosensitive member; a rotating polygonal mirror configured to deflect the plurality of light beams emitted from the light source such that the plurality of light beams each scan the photosensitive member; and control unit configured to control the speed of rotation of the photosensitive member and to control, in accordance with the speed of rotation of the photosensitive member, the speed of rotation of the rotating polygonal mirror and the number of light-emitting elements to emit light beams to form the electrostatic latent image.

According to the present invention, it is possible to change the process speed to an arbitrary speed.

Further features of the present invention will become apparent from the following description of embodiments (with reference to the attached drawings).

### BRIEF DESCRIPTION OF THE DRAWINGS

FIG. 1 is a view showing an example of the arrangement of an image forming apparatus;

FIGS. 2A, 2B, and 2C are views showing an example of the arrangement of an optical scanning device;

FIG. 3 is a block diagram showing an example of the arrangement of the control unit of the optical scanning device;

FIG. 4 is a control flow flowchart;

FIG. 5 is a view for explaining the operation of a laser scan line at the time of speed change;

FIGS. 6A and 6B are views for explaining the relationship between the process speed and the accumulated light amount of a drum surface; and

FIG. 7 is a view for explaining the conventional operation of a light beam scan line at the time of speed change.

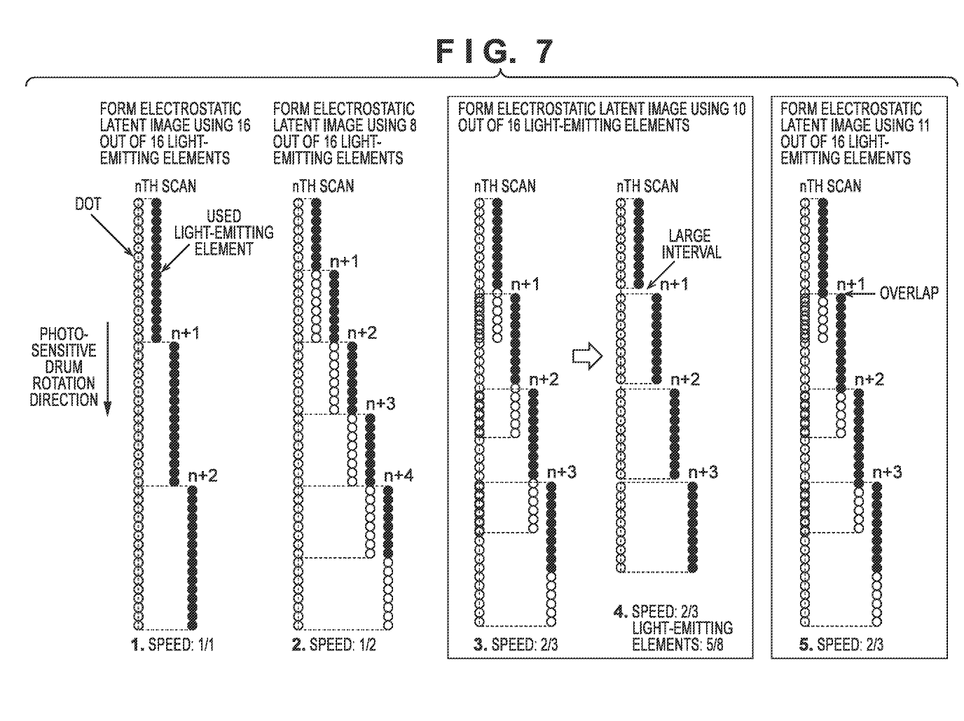

### DESCRIPTION OF THE EMBODIMENTS

### Embodiment

### [Arrangement of Apparatus]

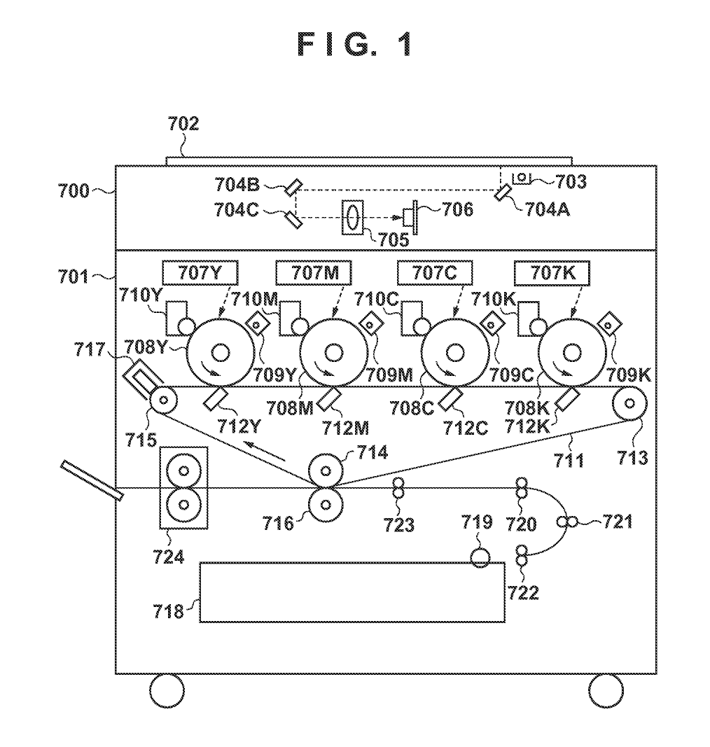

This embodiment will be described using a 4-drum image forming apparatus in which four photosensitive drums that are photosensitive members are juxtaposed. FIG. 1 is a view showing the schematic arrangement of an entire image forming apparatus according to this embodiment. The outline of a color reading apparatus (to be referred to as a “reading apparatus” hereinafter) 700 and a color image forming unit (to be referred to as an “image forming unit” hereinafter) 701 included in the image forming apparatus at the time of standard speed operation will be explained first with reference to FIG. 1.

The reading apparatus 700 causes an illumination lamp 703 to irradiate the image of an original 702 with light and forms an image of light reflected by the original 702 on a color sensor 706 through mirrors 704A, 704B, and 704C and a lens 705.

The color sensor 706 reads blue (to be referred to as B hereinafter), green (to be referred to as G hereinafter), and red (to be referred to as R hereinafter) light as the color image information of the original and converts the light into an electrical image signal. After that, the reading apparatus 700 causes an image processing unit (not shown) to perform color conversion based on the strength levels of the separated B, G, and R image signals output from the color sensor 706. As a result, the reading apparatus 700 obtains four color image data of black (to be referred to as K hereinafter), cyan (to be referred to as C hereinafter), magenta (to be referred to as M hereinafter), and yellow (to be referred to as Y hereinafter). The reference numerals of constituent elements of the respective colors are added with symbols representing the corresponding colors. In this embodiment, red, green, blue, cyan, magenta, yellow, and black are handled, and R, G, B, C, M, Y, and K are added to the reference numerals. Any operation performed commonly without distinction of colors will be described without adding the symbols representing colors to the constituent elements provided for the respective colors.

The outline of the image forming unit 701 will be described next. In the image forming unit 701, optical scanning devices 707M, 707Y, 707C, and 707K provided for the color toners, respectively, convert color image data from the reading apparatus 700 into optical signals. The image forming unit 701 performs optical write corresponding to the original image based on the converted optical signals, and forms electrostatic latent images on photosensitive drums 708Y, 708M, 708C, and 708K provided for the respective colors and rotated. The photosensitive drums 708Y, 708M, 708C, and 708K rotate counterclockwise as indicated by arrows in FIG. 1. Chargers 709Y, 709M, 709C, and 709K provided for the respective colors are arranged around the photosensitive drums 708Y, 708M, 708C, and 708K. Developing units 710Y, 710M, 710C, and 710K are arranged around the photosensitive drums 708Y, 708M, 708C, and 708K of the respective colors in contact with the photosensitive drums 708Y, 708M, 708C, and 708K, respectively.

The image forming unit according to this embodiment includes an intermediate transfer belt 711 serving as an intermediate transfer material, first transfer bias blades 712Y, 712M, 712C, and 712K, a driving roller 713 that drives the intermediate transfer belt 711 by a driving motor (not shown), and driven rollers 714 and 715. The intermediate transfer belt 711 loops over the driving roller 713 and the driven rollers 714 and 715 and rotates in the direction of an arrow as the driving roller 713 rotates.

The image forming unit according to this embodiment also includes a second transfer bias roller 716, the driven roller 714, and a fixing unit 724. The second transfer bias roller 716 is arranged at a position facing the driven roller 714 while sandwiching the intermediate transfer belt 711.

The image forming unit according to this embodiment also includes a belt cleaning unit 717 at a position facing the driven roller 715. The belt cleaning unit 717 collects toners transferred not to a recording medium but to the intermediate transfer belt 711.

The intermediate transfer belt 711 rotates clockwise as indicated by the arrow in FIG. 1. In the image forming unit 701, the yellow, magenta, cyan, and black image forming systems are arranged in this order sequentially from the upstream side with respect to the rotation direction of the intermediate transfer belt 711, and image formation is performed in this order. After the start of yellow image formation, magenta image formation starts at a timing delayed by the interval between the position of the photosensitive drum 708Y and that of the photosensitive drum 708M with respect to the rotation speed of the intermediate transfer belt 711. Then, cyan image formation starts at a timing delayed by the interval between the position of the photosensitive drum 708M and that of the photosensitive drum 708C with respect to the rotation speed of the intermediate transfer belt 711. Next, black image formation starts at a timing delayed by the interval between the position of the photosensitive drum 708C and that of the photosensitive drum 708K with respect to the rotation speed of the intermediate transfer belt 711.

The RGB color data are processed by the image processing unit of the reading apparatus 700 and converted into YMCK color image data. The YMCK image data are stored in a storage unit (not shown) such as the memory of the image forming unit 701. The image forming unit 701 reads out the image data stored in the storage unit and forms an image on each photosensitive drum 708 based on the image data. The detailed image forming process will be described using yellow image formation as an example. The photosensitive drum 708Y sequentially uniformly changed by the charger 709Y in the image forming unit 701 is exposed by a light beam (laser beam), thereby forming an electrostatic latent image on the photosensitive drum 708Y. The developing unit 710Y develops the electrostatic latent image formed on the photosensitive drum 708Y into an yellow toner image. The first transfer bias blade 712Y applies a bias to the yellow toner image formed on the photosensitive drum 708Y so as to transfer the image to the intermediate transfer belt 711. The series of operations is performed in the remaining magenta, cyan, and black units. The toner images of the four colors formed on the photosensitive drums of the respective colors are formed on the intermediate transfer belt 711.

The second transfer bias roller 716 applies a bias to the toner images transferred to the intermediate transfer belt 711 so as to transfer the images to a recording medium (specialty paper such as OHP paper or thick paper or plain paper) conveyed by conveyance rollers 722, 721, 720, and 723 from a paper feed cassette to the transfer portion between the second transfer bias roller 716 and the driven roller 714.

The toner images transferred to the recording medium are fixed to the recording medium through the fixing unit 724. Note that the fixing unit 724 in the image forming apparatus according to this embodiment is a unit that fuses the toners by heat, thereby fixing the toner images to the recording medium. However, either a method of pressurizing toner images and fixing them to a recording medium or a method of fusing toner images by irradiating them with light and fixing them to a recording medium is usable as the fixing method.

[Laser Scanner Unit]

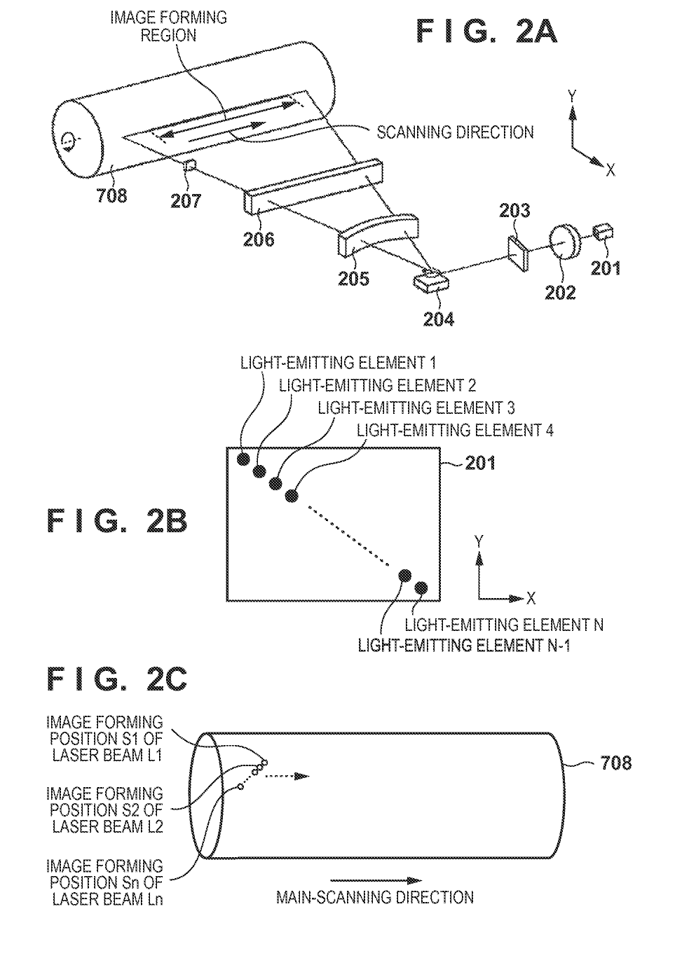

FIG. 2A shows an embodiment of the optical scanning device 707. The optical scanning device 707 includes a light source 201 that generates a laser beam (light beam), a collimator lens 202 that shapes the laser beam into parallel light, a cylindrical lens 203 that condenses the laser beam that has passed through the collimator lens 202 in the sub-scanning direction (direction corresponding to the rotation direction of the photosensitive drum), and a polygonal mirror (rotating polygonal mirror) 204. The optical scanning device 707 also includes an fθ lens A 205 (scan lens A) and an fθ lens B 206 (scan lens B) in which the laser beam (scan light) deflected by the polygonal mirror 204 enters. The optical scanning device 707 further includes a beam detector 207 (to be referred to as a BD 207 hereinafter) that is a signal generation means for detecting the laser beam deflected by the polygonal mirror 204 and outputting a horizontal synchronization signal in accordance with the laser beam detection.

FIG. 2B is an enlarged view of the light source 201. The light source 201 includes N light-emitting elements (light-emitting elements 1 to N) each of which emits a laser beam. In this embodiment, N=16. The light-emitting element 1 emits a laser beam L1, a light-emitting element 2 emits a laser beam L2, and the light-emitting element N emits a laser beam Ln. The X-axis direction in FIG. 2B corresponds to the direction (main-scanning direction) in which each laser beam deflected by the polygonal mirror 204 scans on the photosensitive drum 708. The Y-axis direction corresponds to the rotation direction (sub-scanning direction) of the photosensitive drum 708.

The plurality of light-emitting elements are arranged in an array, as shown in FIG. 2B. Since the light-emitting elements are arranged as shown in FIG. 2B, the laser beams L1 to Ln emitted by the light-emitting elements form images at different positions on the photosensitive drum 708 in the main-scanning direction, as shown in FIG. 2C. In addition, the laser beams L1 to Ln emitted by the light-emitting elements form images at different positions in the sub-scanning direction. Note that the arrangement of the plurality of light-emitting elements may be a two-dimensional arrangement.

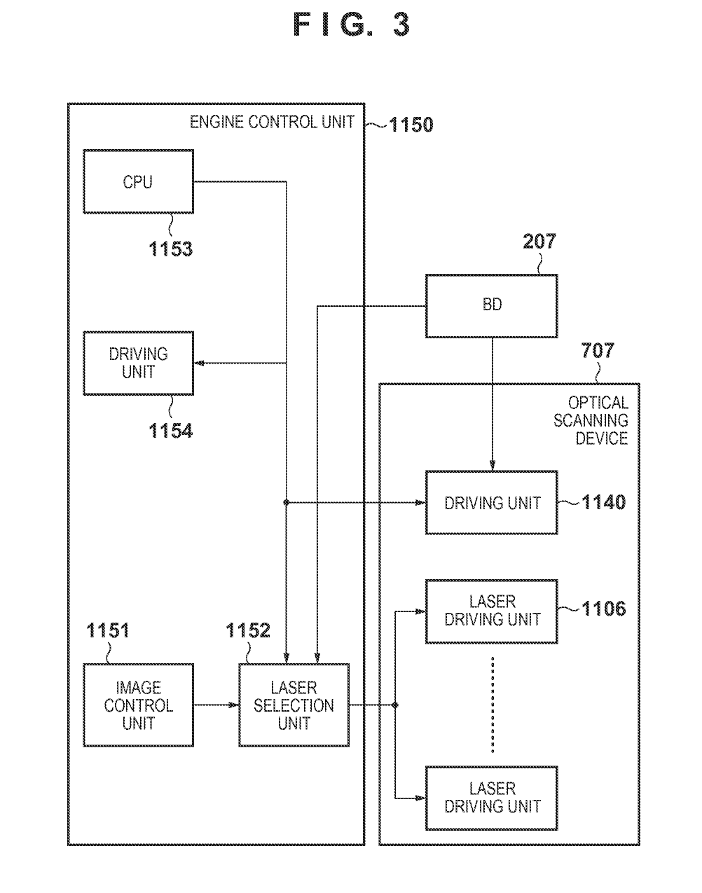

The block diagram of the image forming apparatus shown in FIG. 3 will be explained. The image forming apparatus includes an engine control unit 1150, the optical scanning device 707, and the BD 207. The engine control unit 1150 includes an image control unit 1151, a laser selection unit 1152, and a CPU 1153. The engine control unit 1150 also includes a driving unit 1154 that rotates the intermediate transfer belt 711, rotates the photosensitive drum 708, and conveys the recording medium through the fixing unit 724. The optical scanning device 707 includes a driving unit 1140 including a driving motor and a driving IC, which rotate the polygonal mirror, and a plurality of laser driving units 1106.

The CPU 1153 controls the rotation speed of the photosensitive drum 708, the rotation speed of the intermediate transfer belt 711, and the recording medium conveyance speed through the fixing unit 724 in accordance with the type of the recording medium. More specifically, the CPU 1153 sets a higher image forming speed (process speed) when forming an image on plain paper than when forming an image on specialty paper such as thick paper or OHP paper. For this purpose, the CPU 1153 controls the rotation speed of the photosensitive drum 708, the rotation speed of the intermediate transfer belt 711, and the recording medium conveyance speed through the fixing unit 724 when forming an image on plain paper to higher speeds than those when forming an image on specialty paper such as thick paper or OHP paper.

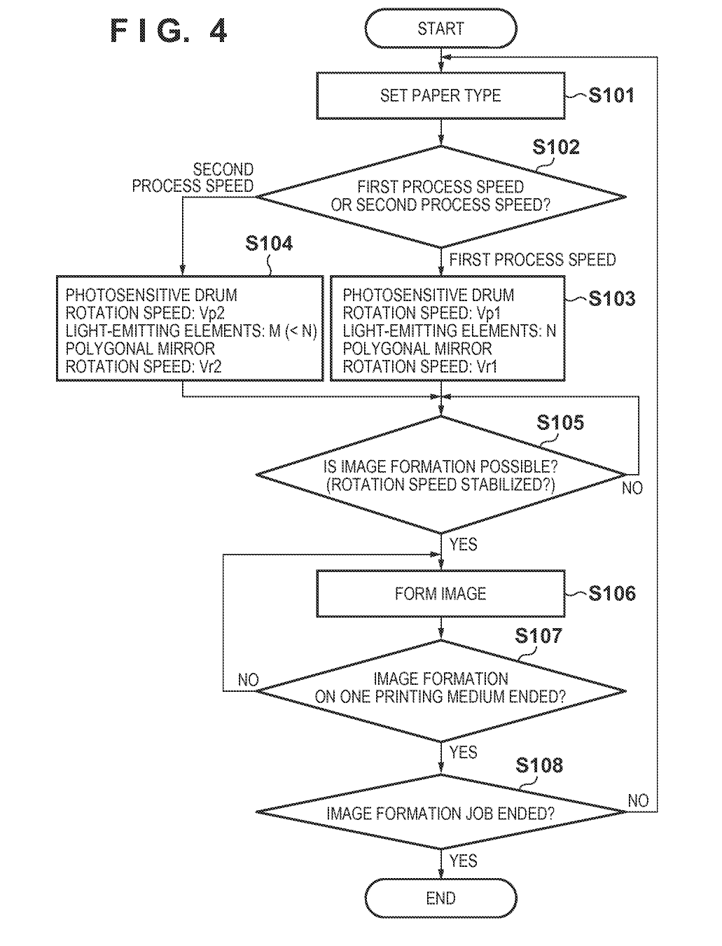

The image control unit 1151 processes the color data included in the image and transmits the data to the laser selection unit 1152. The laser selection unit 1152 divides the image data sent from the image control unit 1151 into image data corresponding to the respective light-emitting elements of a light-emitting element unit including 16 light-emitting elements. The laser selection unit 1152 transfers the divided image data to the laser driving units 1106 corresponding to the respective light-emitting elements. The CPU 1153 decides whether to perform image formation at a first process speed corresponding to plain paper or perform image formation at a second process speed corresponding to specialty paper in accordance with the flowchart shown in FIG. 4. Note that the plurality of light-emitting elements in the light source 201 are arranged such that light beams emitted by the light-emitting elements irradiate different positions in the rotation direction of the photosensitive drum.

(Operation at Normal Speed)

A control procedure executed by the CPU 1153 will be described with reference to FIG. 4. The CPU 1153 accepts a paper type setting selected by the user from an operation unit (not shown) with which the user inputs data (step S101). The CPU 1153 determines based on the paper type setting in step S101 whether to form an image at a first process speed corresponding to plain paper or form an image at a second process speed corresponding to specialty paper (step S102). Upon determining in step S102 to form an image at the first process speed, the CPU 1153 transmits control signals to the driving unit 1154, the laser selection unit 1152, and the driving unit 1140 such that the rotation speed of the photosensitive drum 708, the rotation speed of the intermediate transfer belt 711, the plain paper conveyance speed through the fixing unit 724, the rotation speed of the polygonal mirror 204, and the number of light-emitting elements to be used for electrostatic latent image formation correspond to the first process speed (step S103). At this time, the driving unit 1154 controls the rotation speed of the photosensitive drum 708 to a first rotation speed Vp1 based on the control signal from the CPU 1153. Based on the control signal from the CPU 1153, the laser selection unit 1152 causes N light-emitting elements (16 in this embodiment) to emit light beams based on the image data. The driving unit 1140 controls the rotation speed of the polygonal mirror 204 to Vr1 based on the control signal from the CPU 1153.

On the other hand, upon determining in step S102 to form an image at the second process speed, the CPU 1153 transmits control signals to the driving unit 1154, the laser selection unit 1152, and the driving unit 1140 such that the rotation speed of the photosensitive drum 708, the rotation speed of the intermediate transfer belt 711, the plain paper conveyance speed through the fixing unit 724, the rotation speed of the polygonal mirror 204, and the number of light-emitting elements to be used for electrostatic latent image formation correspond to the second process speed (step S104). At this time, the driving unit 1154 controls the rotation speed of the photosensitive drum 708 to a second rotation speed Vp2 based on the control signal from the CPU 1153. Based on the control signal from the CPU 1153, the laser selection unit 1152 causes M light-emitting elements (10 in this embodiment) to emit light beams based on the image data. The driving unit 1140 controls the rotation speed of the polygonal mirror 204 to Vr2 based on the control signal from the CPU 1153.

After step S103 or S104, the CPU 1153 determines whether image formation is possible (step S105). More specifically, the CPU 1153 determines whether the photosensitive drum 708 and the polygonal mirror 204 are rotating at the rotation speeds set in step S103 or S104. Upon determining that image formation is possible (YES in step S105), the CPU 1153 forms an image under the image forming condition set in step S103 to S104 (step S106). Upon determining that image formation is impossible (NO in step S105), the CPU 1153 returns the control to step S105.

After step S106, the CPU 1153 determines whether image formation on one recording medium has ended (step S107). Upon determining that image formation on one recording medium has ended (YES in step S107), the CPU 1153 advances the control to step S108. Upon determining that image formation on one recording medium has not ended (NO in step S107), the CPU 1153 returns the control to step S106.

Upon determining that image formation on one recording medium has ended (YES in step S107), the CPU 1153 determines whether image formation based on all input image formation jobs has ended (step S108). If not all image formation jobs have ended, and image formation based on the next image formation job is to be performed (NO in step S108), the CPU 1153 returns the control to step S101. If all image formation jobs have ended (YES in step S108), the CPU 1153 ends the control.

The combination of the rotation speed of the polygonal mirror 204 and the number of light-emitting elements to emit light out of the plurality of light-emitting elements is changed to uniform the intervals of scan lines formed by scanning the plurality of light beams on the photosensitive drum 708. In this embodiment, emphasis is placed on speed change by changing the number of light-emitting elements to emit light, thereby suppressing the speed change width of the motor and the light amount variation width of the light-emitting elements.

The image forming apparatus of this embodiment meets

Vp2/Vp1=M/N×Vr2/Vr1 (1)

P2/P1=Vr2/Vr1 (2)

where Vp1: the rotation speed (first rotation speed) of the photosensitive drum when forming an image at the normal process speed

Vp2: the rotation speed (second rotation speed) of the photosensitive drum corresponding to the process speed when forming an image on thick paper or OHP paper

N: the number of light-emitting elements (N light-emitting elements) to emit laser beams to form an electrostatic latent image on the photosensitive drum when forming an image at the normal process speed

M: the number of light-emitting elements (M light-emitting elements) to emit laser beams to form an electrostatic latent image on the photosensitive drum when forming an image at the process speed corresponding to thick paper or OHP paper

Vr1: the rotation speed of the motor (polygonal mirror) when forming an image at the normal process speed

Vr2: the rotation speed of the motor (polygonal mirror) when forming an image at the process speed corresponding to thick paper or OHP paper

P1: the light amount of a laser beam emitted by each light-emitting element used when forming an image at the normal process speed

P2: the light amount of a laser beam emitted by each light-emitting element used when forming an image at the process speed corresponding to thick paper or OHP paper

That is, the number of light-emitting elements used to form an electrostatic latent image is decided, and the rotation speed of the polygonal mirror 204 is controlled in accordance with the decided number of light-emitting elements. In this case, under the condition of this embodiment, N=16, M=10, and Vp2/Vp1=2/3. From equation (1), we obtain Vr2/Vr1=16/15. That is, the rotation speed Vr2 of the polygonal mirror when forming an image on thick paper or OHP paper is controlled to be 16/15 times as high as the rotation speed Vr1 of the polygonal mirror 204 when forming an image at the normal process speed.

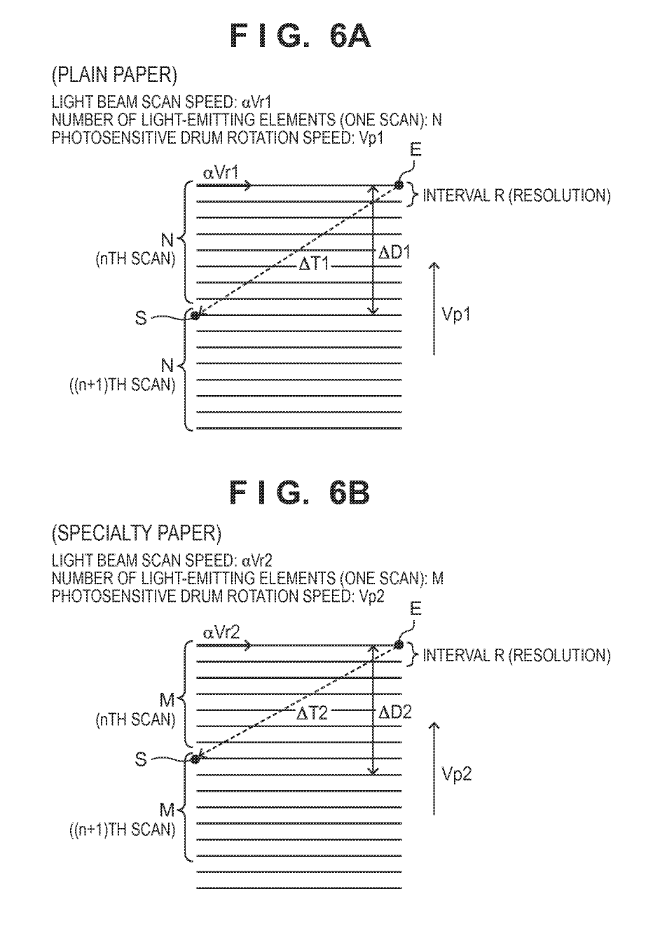

Equation (1) will be explained in detail with reference to FIGS. 6A and 6B. FIGS. 6A and 6B show the scan lines of a light beam on the photosensitive drum 708 when forming an electrostatic latent image on the photosensitive drum 708. The horizontal direction is the direction almost parallel to the rotation axis of the photosensitive drum 708 or the scanning direction of the light beam. The vertical direction is the rotation direction of the photosensitive drum 708. Note that depiction of the photosensitive drum 708 is omitted.

As shown in FIG. 6A, when forming an image on plain paper, an electrostatic latent image is formed using N light-emitting elements, the polygonal mirror 204 is controlled to the rotation speed Vr1, and the photosensitive drum 708 is controlled to the rotation speed Vp1. On the other hand, as shown in FIG. 6B, when forming an image on specialty paper, an electrostatic latent image is formed using M light-emitting elements, the polygonal mirror 204 is controlled to the rotation speed Vr2, and the photosensitive drum 708 is controlled to the rotation speed Vp2. Note that the scan speed of the light beam scanning on the photosensitive drum 708 when the polygonal mirror 204 is controlled to the rotation speed Vr1 is represented by αVr1. Similarly, the scan speed of the light beam scanning on the photosensitive drum 708 when the polygonal mirror 204 is controlled to the rotation speed Vr2 is represented by αVr2. α is the conversion factor used to convert the rotation speed of the polygonal mirror 204 into the scan speed of the light beam on the photosensitive drum 708. Since the distances from an end point E to a start point S of the scan line equal,

ΔT1×αVr1=ΔT2×αVr2 (3)

holds, where ΔT1 is the time needed for scan from the end point E to the start point S of the scan line when the scan speed is αVr1, and ΔT2 is the time needed for scan from the end point E to the start point S of the scan line when the scan speed is αVr2. Note that in the section from the end point E to the start point S, the light-emitting elements do not emit laser beams except for light emission for inputting a laser beam to the BD 207 and laser beam emission for light amount control. From equation (3), we obtain

ΔT1/ΔT2=Vr2/Vr1 (4)

Let ΔD1 be the interval between the first scan line in the nth scan and the first scan line in the (n+1)th scan when forming an electrostatic latent image on plain paper, and R be the interval (resolution) between adjacent scan lines. In this case,

ΔD1=Vp1×ΔT1 (5)

ΔD1=N×R (6)

hold. From equations (5) and (6),

N×R=Vp1×ΔT1 (7)

holds.

Similarly, let ΔD2 be the interval between the first scan line in the nth scan and the first scan line in the (n+1)th scan when forming an electrostatic latent image on specialty paper, and R be the interval (resolution) between adjacent scan lines. In this case,

ΔD2=Vp2×ΔT2 (8)

ΔD2=M×R (9)

hold. From equations (8) and (9),

M×R=Vp2×ΔT2 (10)

holds.

In addition, from equations (7) and (10),

Vp1×ΔT1/N=Vp2×ΔT2/M (11)

holds.

Hence, equation (1) holds from equations (4) and (11).

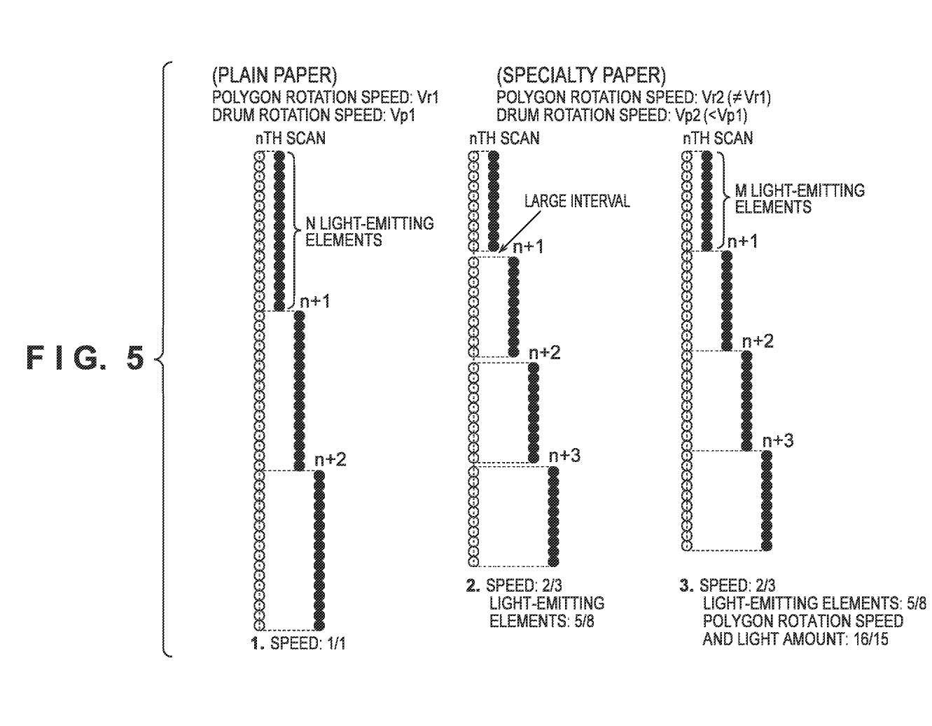

Item 1 of FIG. 5 is a view for explaining the intervals of scan lines in a plurality of scan periods (nth period to (n+2)th period) when the number of light-emitting elements is 16 (N). In Item 1 of FIG. 5, the rotation speed of the photosensitive drum is Vp1, and the rotation speed of the polygonal mirror 204 is Vr1. That is, Item 1 of FIG. 5 shows the image forming condition when forming an image on plain paper. Item 2 of FIG. 5 is a view for explaining the intervals of scan lines in a plurality of scan periods (nth period to (n+2)th period) when the rotation speed of the photosensitive drum 708 is controlled to Vp2 that is 2/3 of Vp1, the number of light-emitting elements in use is 10 (M), and the rotation speed of the polygonal mirror 204 is controlled to Vr1. Item 3 of FIG. 5 is a view for explaining the intervals of scan lines in a plurality of scan periods (nth period to (n+2)th period) when the rotation speed of the photosensitive drum 708 is controlled to Vp2 that is 2/3 of Vp1, the number of light-emitting elements in use is 10 (M), and the rotation speed of the polygonal mirror 204 is controlled to Vr2 that is 16/15 of Vr1.

When forming an image on plain paper, the intervals of the scan lines can be uniformed by forming an electrostatic latent image under the image forming condition shown in Item 1 of FIG. 5. However, when the process speed and the number of light-emitting elements are changed, and image formation is performed, as shown in Item 2 of FIG. 5, the scan lines have intervals equal to or more than the resolution, as indicated by an arrow. To correct the intervals equal to or more than the resolution, the rotation speed of the polygonal mirror 204 is increased, thereby decreasing the interval indicated by the arrow in Item 2 of FIG. 5.

Note that when the rotation speed of the polygonal mirror 204 is increased, the image width in the light beam scanning direction becomes smaller than the desired width, and when the rotation speed of the polygonal mirror 204 is decreased, the image width in the light beam scanning direction becomes larger than the desired width. The image forming apparatus according to this embodiment corrects the image width in the light beam scanning direction to the desired width by a known technique.

For example, image data is processed in synchronism with an image clock signal, thereby generating a driving signal (PWM (Pulse Width Modulation) signal) to cause a light-emitting element to emit a laser beam. The image width is defined by the frequency of the image clock signal. The image forming apparatus of this embodiment lowers the frequency of the image clock when the rotation speed of the polygonal mirror 204 increases, thereby correcting the image width in the light beam scanning direction to the desired width. Note that the image width may be increased by correcting the image data and thus generating a correction pixel or a correction auxiliary pixel, or the image width may be decreased by deleting image data corresponding to a pixel or an auxiliary pixel from existing data.

The exposure amount per unit area on the photosensitive drum 708 exposed by one laser beam when the rotation speed of the polygonal mirror 204 is controlled to Vr1 (when the photosensitive drum 708 is controlled to Vp1 ((a first mode))) is larger than the exposure amount per unit area on the photosensitive drum 708 exposed by one laser beam when the rotation speed of the polygonal mirror 204 is controlled to Vr2 (when the photosensitive drum 708 is controlled to Vp2 (a second mode)). Hence, the CPU 1153 controls the light amount such that the light amount P2 of a laser beam when the rotation speed of the polygonal mirror 204 is Vr2 becomes larger than the light amount P1 of a laser beam when the rotation speed of the polygonal mirror 204 is Vr1 (for example, control is done to meet equation (2)).

For example, the laser selection unit 1152 drives 10 light-emitting elements (M=10) that is 5/8 of the total of 16 elements at the standard speed via the laser driving unit 1106 such that the light amount becomes 16/15 (P2/P1=Vr2/Vr1=16/15) to the light amount of 16 light-emitting elements when the electrostatic latent image is formed with 16 light-emitting elements. In a case where a resolution capability of the control of the rotation speed of the polygonal mirror 204 is not corresponding to a resolution capability of the control of the light amount, the laser driving unit 1106 controls 10 light-emitting elements such that the light amount substantially becomes Vr2/Vr1 to the light amount of 16 light-emitting elements when the electrostatic latent image is formed with 16 light-emitting elements.

As described above, an image is formed on paper such as thick paper or OHP paper by laser beams having a light amount 16/15 times as large as that for plain paper by setting the rotation speed of the polygonal mirror 204 to 16/15×5/8 (the number of light-emitting elements)=2/3. Toner images are formed on the recording medium by the same operation as in the above-described image formation at the normal speed and sufficiently fixed at the 2/3 speed, thereby obtaining a full-color copy.

In this embodiment, the speed change amount is obtained in accordance with equation (1). However, the equation to obtain the combination of the rotation speed of the motor and the number of light-emitting elements to emit light out of the plurality of light-emitting elements is not limited to equation (1), as a matter of course. For example, a coefficient may separately be given to vary the ratio.

In this embodiment, the light amount is obtained in accordance with equation (2). However, the equation to obtain the light amount to be changed is not limited to equation (2), as a matter of course. For example, a coefficient may separately be given to vary the ratio.

In this embodiment, the procedure of deciding the light-emitting elements to be used when changing the speed and then controlling the rotation speed of the polygonal mirror and the amount of light to be emitted by the light-emitting elements has been described. However, the present invention is not limited to this arrangement. For example, the control may be done to first decide the rotation speed of the polygonal mirror and the amount of light to be emitted by the light-emitting elements and then decide the light-emitting elements to be used.

The image forming apparatus according to this embodiment executes the above-described control when Vp2/Vp1=1/X (X is a natural number) is not met. On the other hand, when Vp2/Vp1=1/X (X is a natural number) is met, the rotation speed of the polygonal mirror is controlled to Vr1, and N light-emitting elements are caused to emit the light beams to form an electrostatic latent image every time X BD signals are detected.

An example has been described above in which the light emission control is performed to refrain from using part of the light-emitting elements and the polygonal mirror. However, it is not always necessary to control to refrain from using part of both the light-emitting elements and the polygonal mirror. Although the rotation speed of the polygonal mirror and the light emission amount of the light-emitting elements are controlled, it is not always necessary to control both, and only one of them may be changed in accordance with the process speed.

As described above, it is possible to form an image at the process speed changed to an arbitrary speed by controlling the number of light-emitting elements to be used for electrostatic latent image formation and the rotation speed of the polygonal mirror.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2012-094179, filed Apr. 17, 2012, and 2013-052429, filed Mar. 14, 2013, which are hereby incorporated by reference herein in their entirety.

What is claimed is:

1. An image forming apparatus comprising:
a photosensitive member to be rotated;
a light source including a plurality of light-emitting elements each of which is controllable separately and is configured to emit a light beam to form an electrostatic latent image on the photosensitive member, the plurality of light-emitting elements being arranged such that the light beams emitted from each of the plurality of light-emitting elements expose different positions of the photosensitive member in the direction of rotation of the photosensitive member;
a rotating polygonal mirror configured to deflect the plurality of light beams emitted from the light source such that the plurality of light beams each scan the photosensitive member; and
a control unit configured to control a speed of rotation of the photosensitive member, a speed of rotation of the rotating polygonal mirror, and the number of light-emitting elements, out of the plurality of light-emitting elements, being used to emit a light beam to form an electrostatic latent image on the photosensitive member,
wherein in a state where the control unit controls the speed of rotation of the photosensitive member to be Vp1, the control unit causes N light-emitting elements out of said plurality of light-emitting elements to emit light beams and controls the speed of rotation of the rotating polygonal mirror to be Vr1, and in a state where the control unit controls the speed of rotation of the photosensitive member to be Vp2, where Vp2 is lower than Vp1, the control unit causes M light-emitting elements, out of said plurality of light-emitting elements, to emit the light beams, where M<N, and controls the speed of rotation of the rotating polygonal mirror to be Vr2 which is different to Vr1.

2. The apparatus according to claim 1, wherein in a state where a product of Vp2/Vp1 and the number N of light-emitting elements is not a natural number, and the speed of rotation speed of the photosensitive member is controlled to be Vp1, the control unit is configured to cause the N light-emitting elements, out of said plurality of light-emitting elements, to emit light beams and controls the speed of rotation of the rotating polygonal mirror to be Vr1, and
in a state where the product of Vp2/Vp1 and the number N of light-emitting elements is not a natural number, and the control unit controls the speed of rotation of the photosensitive member to be Vp2, which is lower than Vp1, the control unit is configured to causes the M light-emitting elements, out of said plurality of light-emitting elements, where M<N, to emit the light beams and controls the speed of rotation of the rotating polygonal mirror to be Vr2 which is different to Vr1.

3. The apparatus according to claim 2, wherein in a state where the control unit controls the rotation speed of the photosensitive member to be Vp2, the control unit is configured to control the number, M, of light-emitting elements to emit light beams such that M equals a natural number part of the product of Vp2/Vp1 and N and controls the speed of rotation of the rotating polygonal mirror to be Vr2, which is greater than Vr1.

4. The apparatus according to claim 2, wherein in a case where the control unit controls the rotation speed of the photosensitive member to be Vp2, the control unit is configured to control the number, M, of light-emitting elements to emit the light beams such that M equals a value obtained by adding 1 to a natural number part of the product of Vp1/Vp2 and N and controls the speed of rotation of the rotating polygonal mirror to be Vr2, which is lower than Vr1.

5. The apparatus according to claim 1, wherein the equation:
Vp2/Vp1=M/N×Vr2/Vr1
is met.

6. The apparatus according to claim 1, wherein the control unit is configured to control, based on the speed of rotation of the photosensitive member, a light amount of the light beams emitted by the light source to form the electrostatic latent image.

7. The apparatus according to claim 6, wherein the control unit is configured to control the ratio of a light amount P1 in a state where the control unit controls the rotation speed of the photosensitive member to be Vp1, and the light amount P2 in a state where the control unit controls the speed of rotation of the photosensitive member to be Vp2, wherein the equation:
P2/P1=Vr2/Vr1
is met.

8. The apparatus according to claim 1, further comprising detection unit configured to detect, at least, one light beam deflected by the rotating polygonal mirror and to generate a detection signal,
wherein in case where the control unit controls the speed of rotation of the photosensitive member to be Vp2 and Vp2 does not meet Vp2/Vp1=1/X, where X is a natural number, the control unit is configured to cause the M light-emitting elements to emit the light beams to form the electrostatic latent image and controls the speed of rotation of the rotating polygonal mirror to be Vr2, which is higher than Vr1, and
in a case where the control unit controls the speed of rotation of the photosensitive member to Vp2 and Vp2 meets Vp2/Vp1=1/X, where X is a natural number, the control unit controls the rotation speed of the rotating polygonal mirror to be Vr1 and causes the N light-emitting elements to emit light beams to form the electrostatic latent image every time the X detection signals are detected.

9. The apparatus according to claim 1 further comprising:
a developing unit configured to develop the electrostatic latent image formed on the photosensitive member using a toner;
a transfer unit configured to transfer a toner image formed on the photosensitive member to a recording medium; and
a fixing unit configured to fix the toner image to the recording medium by passing the recording medium with the transferred toner image through a fixing unit,
wherein a speed at which the recording medium on which the toner image formed by controlling the rotation speed of the photosensitive member to Vp2, where Vp2<Vp1, is transferred passes through the fixing unit is lower than a speed at which the recording medium on which the toner image formed by controlling the rotation speed of the photosensitive member to Vp1 is transferred passes through the fixing unit.

10. The apparatus according to claim 9
wherein the control unit controls the speed of rotation of the photosensitive member to be Vp1 to form the toner image on a plain paper;
wherein the control unit controls the speed of rotation of the photosensitive member to be Vp2 to form the toner image on the thick paper which is thicker than the plain paper.

11. An image forming apparatus comprising:
a photosensitive member to be rotated;
a light source including a plurality of light-emitting elements each of which is controllable separately and is configured to emit a light beam to form an electrostatic latent image on the photosensitive member when in use, the plurality of light-emitting elements being arranged such that the light beams emitted from each of the plurality of light-emitting elements expose different positions on the photosensitive member in the direction of rotation of the photosensitive member;
a rotating polygonal mirror configured to deflect the plurality of light beams emitted from the light source such that the plurality of light beams each scan the photosensitive member; and
a control unit configured to control the speed of rotation of the photosensitive member and to control, in accordance with the speed of rotation of the photosensitive member, the speed of rotation of the rotating polygonal mirror and the number of light-emitting elements to emit light beams to form the electrostatic latent image.

12. The apparatus according to claim 11,
wherein the control unit is configured to control, in accordance with the speed of rotation of the photosensitive member, the light amount of the light beams emitted from the light-emitting elements to form the electrostatic latent image.

13. The apparatus according to claim 11,
wherein the control unit is configured to control the number of light-emitting elements to emit light beams based on the speed of rotation of the rotating polygonal mirror, which is controlled in accordance with the speed of rotation of the photosensitive member.

14. The apparatus according to claim 11, wherein the control unit is configured to control the speed of rotation of the rotating polygonal mirror based on the number of light-emitting elements controlled in accordance with the speed of rotation of the photosensitive member.

15. The apparatus according to claim 11, further comprising:
a developing unit configured to develop the electrostatic latent image formed on the photosensitive member using a toner;
a transfer unit configured to transfer a toner image formed on the photosensitive member to a recording medium; and
a fixing unit configured to fix the toner image to the recording medium by passing the recording medium with the transferred toner image through a fixing unit,
wherein a speed at which the recording medium on which the toner image formed by controlling the rotation speed of the photosensitive member to a first rotation speed is transferred passes through the fixing unit is lower than a speed at which the recording medium on which the toner image formed by controlling the rotation speed of the photosensitive member to a second rotation speed higher than the first rotation speed is transferred passes through the fixing unit.
